(19) United States
(12) Patent Application Publication
(10) Pub. No.: US 2011/0137721 A1
(43) Pub. Date: Jun. 9, 2011

(54) MEASURING ADVERTISING EFFECTIVENESS WITHOUT CONTROL GROUP

(75) Inventor: Harvir Singh Bansal, Reston, VA (US)

(73) Assignee: comScore, Inc., Reston, VA (US)

(21) Appl. No.: 12/959,878

(22) Filed: Dec. 3, 2010

Related U.S. Application Data
(60) Provisional application No. 61/266,425, filed on Dec. 3, 2009.
(60) Provisional application No. 61/348,079, filed on May 25, 2010.

(51) Int. Cl. G06Q 30/00

(52) U.S. Cl. 705/14.41

(57) ABSTRACT

Measurement data is accessed. The measurement data is associated with a group of users that have been exposed to at least one advertising creative that is part of an advertising campaign. The measurement data reflects one or more consumer responses and one or more non-zero exposure levels. The non-zero exposure levels correspond to non-zero amounts of exposures to at least one advertising creative that is part of the advertising campaign. A model that relates consumer response measures to one or more exposure levels is generated based on the accessed measurement data. Based on the generated model, a consumer response measure for a zero exposure level is determined. The zero exposure level corresponds to a zero amount of exposures to at least one advertising creative that is part of the advertising campaign. An advertising effectiveness metric is determined based on the consumer response measure for the zero exposure level and the accessed measurement data.

### CROSS-REFERENCE TO RELATED APPLICATIONS

This application claims priority under 35 USC §119(e) to U.S. Provisional Application Ser. No. 61/266,425, filed on Dec. 3, 2009, and titled “Ad Effectiveness Without Control Group” and U.S. Provisional Application Ser. No. 61/348,079, filed on May 25, 2010, and titled “Ad Effectiveness without Control Group,” all of which are hereby incorporated by reference.

### BACKGROUND

In general, advertisers may want metrics that inform the advertisers about the effectiveness of a given advertising campaign. The advertisers may want to understand the advertising effectiveness across one or more different advertising effectiveness metrics, such as unaided awareness, recall, brand favorability, intent to purchase, and brand recommendation.

### SUMMARY

In one aspect, measurement data is accessed. The measurement data is associated with a group of users that have been exposed to at least one advertising creative that is part of an advertising campaign. The measurement data reflects one or more consumer responses and one or more non-zero exposure levels. The non-zero exposure levels correspond to non-zero amounts of exposures to at least one advertising creative that is part of the advertising campaign. A model that relates consumer response measures to one or more exposure levels is generated based on the accessed measurement data. Based on the generated model, a consumer response measure for a zero exposure level is determined. The zero exposure level corresponds to a zero amount of exposures to at least one advertising creative that is part of the advertising campaign. An advertising effectiveness metric is determined based on the consumer response measure for the zero exposure level and the accessed measurement data.

Implementations may include one or more of the following features. For example, each of the one or more non-zero exposure levels may correspond to an individual, non-zero number of exposures. Generating the model may include generating, based one the accessed measurement data, a model that relates consumer response measures to exposure levels while holding other factors constant. The other factors may include age, gender, income level, or usage. The consumer response measures may be probabilities of a positive consumer response.

Determining the advertising effectiveness metric may include determining an estimate of the exposure distribution for the advertising campaign, the exposure distribution including one or more non-zero exposure levels experienced during the campaign; determining, based on the model, consumer response measures for the non-zero exposure levels in the estimate of the exposure distribution; determining changes of the determined consumer response measures for the non-zero exposure levels in the estimate of the exposure distribution relative to the consumer response measure for the zero exposure level; and determining an advertising effectiveness metric based on the changes. Determining the estimate may include determining the non-zero exposure levels reflected by the measurement data. Determining an advertising effectiveness metric based on the changes may include determining a proportion of the users in the group at each non-zero exposure level reflected by the measurement data; weighting the changes by the corresponding proportions; and summing the weighted changes. The changes may be percent changes and the proportions may be the percentages of users in the group at each non-zero exposure level.

Determining the estimate may include determining one or more non-zero exposure levels experienced by users of a panel. Determining an advertising effectiveness metric based on the changes may include determining a proportion of the users in the panel at each non-zero exposure level experienced by the users of the panel; weighting the changes by the corresponding proportions; and summing the weighted changes

Determining the advertising effectiveness metric may include determining a non-zero exposure level that corresponds to an average number of exposures for the group; determining a consumer response measure for the non-zero exposure level that corresponds to an average number of exposures for the group; and determining a change of the consumer response measure for the non-zero exposure level that corresponds to an average number of exposures for the group relative to the consumer response measure for the zero exposure level. The change may be a percent change.

The advertising effectiveness measure may indicate an effectiveness with respect to one or more attitudinal or behavioral responses. The attitudinal responses may include one or more of brand favorability, intent to purchase, brand recommendation, unaided awareness, or recall The behavioral responses may include one or more of website visitation, brand, product, or service searching, or purchase of a product or service.

In another aspect, measurement data is accessed. The measurement data is associated with a group of users that have been exposed to at least one advertising creative that is part of an advertising campaign. The measurement data reflects, for each one of multiple non-zero exposure levels, an amount of the users from the group corresponding to a positive consumer response. Each non-zero exposure level corresponds to a non-zero amount of exposures to at least one advertising creative that is part of the advertising campaign. A model that relates probabilities of a positive consumer response to exposure levels is generated based on the accessed measurement data. Based on the generated model, a probability of a positive consumer response for a zero exposure level is determined. The zero exposure level corresponds to a zero amount of exposures to at least one advertising creative that is part of the advertising campaign. An advertising effectiveness metric is determined based on the probability of a positive consumer response for the zero exposure level and the accessed measurement data.

Implementations of any of the techniques described in this document may include a method or process, an apparatus, a machine, a system, or instructions stored on a computer-readable storage device. The details of particular implementations are set forth in the accompanying drawings and description below. Other features will be apparent from the following description, including the drawings, and the claims.

### BRIEF DESCRIPTION OF THE DRAWINGS

FIG. 1A is a block diagram of an example of a system for providing advertisements to viewers of web pages or other network-accessible resources and to measure consumer responses of at least some of those viewers.

FIG. 1B shows an example block diagram of a webpage.

FIG. 2 illustrates an example of a system in which effectiveness measurement data can be used to generate an advertising effectiveness metric.

FIG. 3 is a flow chart illustrating an example of a process for determining an advertising effectiveness metric for one or more advertising campaigns.

### DETAILED DESCRIPTION

The following describes techniques for determining advertising effectiveness by modeling, rather than empirically deriving, a control group response. In general, one manner of ascertaining the effectiveness of one or more advertisements included in an advertising campaign involves insuring that there is a control group of consumers that have not been exposed to an advertisement in the campaign and measuring consumer responses of some portion of consumers in the control group and some portion of the consumers that have been exposed (the test group). For example, consumers in both the control and test groups may be invited to take a survey. The surveys may be used to determine consumer response measures for the control group and the test group, and a comparison of these consumer response measures may be used to determine a metric of advertising effectiveness.

In one implementation of the techniques described in this document, responses of a portion of consumers in a test group are used to develop a model of consumer response measures versus exposure frequency. This model is then used determine a control response measure (a consumer response measure for zero exposures to an advertisement in the campaign). An advertising effectiveness measure is then determined based on the change between one or more of the consumer response measures for the portion of consumers and the control response measure.

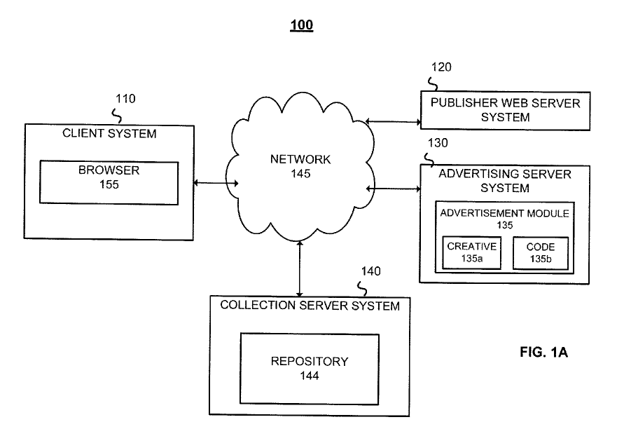

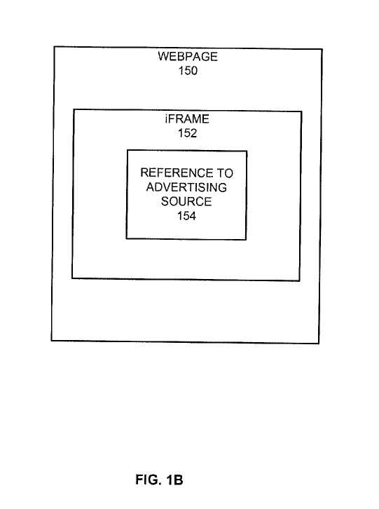

Referring to FIG. 1A, a system 100 includes one or more client systems 110, one or more publisher web server system 120, one or more advertising server systems 130, and one or more collection server systems 140 that communicate and exchange data through a network 145. The system 100 may be used to provide advertisements to viewers of web pages or other network-accessible resources and to measure consumer responses of at least some of those viewers.

Each of the client system 110, the publisher web server system 120, the advertising server system 130, and the collection server system 140 may be implemented using, for example, one or more processing devices capable of responding to and executing instructions in a defined manner, including, for instance, a general-purpose computer, a personal computer, a special-purpose computer, a workstation, a server, or a mobile device. The client system 110, the publisher web server system 120, the advertising server system 130, and the collection server system 140 may receive instructions from, for example, a software application, a program, a piece of code, a device, a computer, a computer system, or a combination thereof, which independently or collectively direct operations. The instructions may be embodied permanently or temporarily in any type of machine, component, equipment, or other physical storage medium that is capable of being used by the client system 110, the publisher web server system 120, the advertising server system 130, and the collection server system 140.

In general, the client system 110 includes a web browser 155 that can be used by a user of the client system 110 to retrieve and display web pages or other resources over the network 145, such as the Internet. The publisher web server system 120 may store such web pages or other resources, and transmit those web pages to the client system 110 when requested by the web browser 155.

The advertising server system 130 may store one or more advertisement modules 130 that are retrieved and rendered as part of one or more of the web pages provided by the publisher web server system 120. The advertising module 135 may be, for example, implemented as an Hypertext Markup Language (HTML) file, a shockwave application, or a Java applet.

The advertising module 135 includes an advertising creative 135a. The advertising creative 135a in a given advertisement module 135 is the image, video, sound, or other information that is to be displayed when the advertising module 135 is rendered by a web browser and the displayed creative is to be perceived by a person.

While only a single advertisement module is illustrated, the advertising server system may store multiple advertisement modules, and the advertisement modules may be organized according to advertising campaigns. In general, an advertising campaign is a collection of one or more advertisement messages or creatives (described below) that share a single idea and/or theme and which typically form an integrated marketing communication (IMC). Thus, the advertisement modules 135 that include creatives 135a belonging to the same advertising campaign may be grouped together as being part of the advertising campaign, and may be associated with a campaign identifier.

The advertising module 135 also includes code 135b. The code 135b is executed when the advertising module 135 is rendered in a web browser (typically as part of a web page, as described below). When the code 135b is executed, the code 135b performs functions related to tracking exposures of the creatives in the advertising campaign as well as providing surveys, as described further below.

FIG. 1B is a diagram illustrating an example of a web page 150 that may be provided by the publishing web server system 120. The web page 150 may include an iFrame 152, which may be located in a portion of the webpage 150 reserved for displaying an advertisement. The iFrame 152 acts as a container, or placeholder, for content and the iFrame 152 includes a reference (e.g, a uniform resource locator (URL)), or a pointer, to an advertising source 154. The advertising source 154 may be, for example, the advertising server system 130. Through the reference to the advertising source 154, the iFrame 152 obtains content for display within the iFrame 152 from the advertising source. For example, the iFrame 152 may reference the advertising server system 130 such that an advertising module 135 is downloaded to the client computer 110 and rendered within the iFrame 152, which may result in the creative 135a being displayed in the iFrame 152 (and thus in the rendered webpage) and the code 135b being executed.

Referring again to FIG. 1A, during operation, the client system 110, through the web browser 155, requests a web page, such as web page 150, from the publishing web server 120. The publishing web server system 120 sends the web page 150 to the client system 110 and the web page 150 is rendered by the web browser 155. When the iFrame 152 is rendered, the reference 154 results in the web browser 155 sending a request to the advertising server system 130 for an advertisement module 135. The advertising server system 130 selects a particular advertisement module 135 and returns the selected advertisement module 135 to the client system 110 for rendering by the web browser 155 in the iFrame 152. While an example employing an iFrame is described, other implementations may include the advertisement module 135 in the web page without using an iFrame.

When the advertisement module 135 is rendered, the creative 135a is displayed in the iFrame 152. In addition, the code 135b is executed. In generally, the code 135b includes exposure code for tracking and reporting the number of times the creative 135a, or another creative in the advertising campaign, has been displayed by the browser 155 (referred to as beacon code). The code 135b also includes survey code for determining whether the user viewing the web page should be solicited to take a survey, as well as providing the survey is the user agrees to take the survey.

In particular, when the beacon code 208 is rendered, the beacon code 208 causes the browser application 204 to send a message to the collection server 130. This message includes certain information. For example, in one implementation, the beacon message may include a campaign project identifier, a creative identifier, an exposure frequency parameter, a client identifier, and an identifier (e.g., URL) of the web page in which the advertisement module 135 is included.

The campaign project identifier identifies the advertising campaign of which the particular creative 135a included with the advertisement module 135 is a part. The campaign project identifier also may identify the associated brand, product, or service associated with the campaign. The creative identifier identifies the specific creative 135a included with the advertisement module 135. As noted earlier, a given advertising campaign may have a number of creatives associated with the campaign.

The exposure frequency parameter indicates how many times a user of the client system 110 has been exposed to creative in the campaign. The number of times an creative of the campaign has been displayed on the client system 110, or at least by the particular web browser 155, may act as a surrogate for the actual number of times a given user has been exposed to a creative in the campaign. This approximation may be useful in scenarios in which it is difficult or impossible to track the actual number of times a particular user is exposed to a creative in the campaign.

In one implementation, the exposure frequency parameter is stored in a cookie on the client system 110. The beacon code 135b may access the cookie, update the exposure frequency parameter in the cookie (to account for the current exposure), and include the updated exposure frequency parameter in the beacon message. The exposure frequency parameter may be associated with a particular campaign identifier and, as a result, multiple exposure frequency parameters and campaign identifiers may be stored in the cookie to indicate the number of exposures to a creative in a particular campaign. In other implementations, different cookies may be used for different campaigns. Also, while the above described implementation counts exposures to creatives in a campaign, other implementations may count the number of exposures to a specific creative in addition to, or as an alternative, to a campaign.

As noted above, the message may also include a unique identifier for the client system 110 (or at least web browser 155). For example, when a client system first sends a beacon message to the collection server 130, a unique identifier may be generated for the client system 110 (and associated with the received beacon message). That unique identifier may then be included in the cookie that is set on that client system 102. As a result, later beacon messages from that client system (or at least from the browser 155) may have the cookie appended to them such that the messages include the unique identifier for the client system 110, or the client identifier may be retrieved from the cookie and included in a parameter of the beacon message. If a beacon message is received from the client system 110 without the cookie (e.g., because the user deleted cookies on the client system 110 or the user of client system 110 is using a browser other than browser 155), then the collection server 140 may again generate a unique identifier and include that identifier in a new cookie set of the client system 140.

The beacon message also may include the URL of the web page in which the advertisement module 135 is included. The beacon code 135b may make a call to the browser 155 for this information, and populate the URL in a parameter of the beacon message.

As an example, the beacon code may be JavaScript code that collects the information t be included in the beacon message as needed and sends the beacon message, including the information, to the collection server 130 as an HTTP Post message that includes the information in a query string. Similarly, the beacon code may be JavaScript code that collects the information as appropriate, and includes that information in the “src” attribute of an <img> tag, which results in a request for the resource located at the URL in the “src” attribute of the <img> tag to the collection server 140. Because the information is included in the “src” attribute, the collection server 140 receives the information. The collection server 140 can then return a transparent image. The following is an example of such JavaScript:

<script type=“text/javascript”>
document.write(“<img id=‘img1’ height=‘1’

width=‘1’>”);document.getElementById(“img1”).src=“http://example.com/scripts/report.dll?P1=
” + escape(window.location.href) + “&rn=” + Math.floor(Math.random( )*99999999);

</script>

The collection server 140 records the information received in the message with, for instance, a time stamp of when the message was received and the IP address of the client system 110 from which the message was received. The collection server 140 aggregates this recorded information and stores this aggregated information in repository 144 as exposure data.

Also as noted above, the beacon code 135b also includes survey code that evaluates certain parameters to determine whether to solicit the user viewing the web page to take a survey. For example, the survey code may evaluate a frequency at which surveys should be solicited, as well as whether or not a survey has been solicited on the client system 110 (which may be indicated, for example, in a cookie on client system 110.

If so, the survey code may cause an invitation to be displayed in web browser 155, where the invitation invites the user to take the survey. Assuming the user agrees to take the survey, the survey code displays the survey, for example, by opening another window or tab of browser 155 and causing the browser 155 to retrieve and display the survey. For instance, the survey may be retrieved from the collection server system 140.

In general, the survey includes questions related to a particular, desired consumer response to the creatives in the advertising campaign. For instance, the survey may include questions related to brand favorability (whether a consumer has a positive attitude towards the brand), intent to purchase (whether the consumer intends to purchase a particular product or service), brand recommendation (whether a consumer would recommend the brand to others), unaided awareness (whether a consumer, without prompting, lists one of the creatives when asked to list all advertisements he or she has seen in a particular category), or recall (whether a consumer lists a particular brand, product, or service when asked to list brands, products, or services in a particular category).

Surveys, such as those for brand favorability, intent to purchase, and brand recommendation may, for example, ask questions related to one or more of these responses, and ask the user to answer by selecting a number on a particular scale. For example, a survey may ask a user to rank, from 1 to 9, how favorably the user thinks about a particular brand. Responses above a certain number may be considered a positive consumer response, while responses below a certain number may be considered negative consumer responses (for example, responses of 8 and 9 may be considered positive responses).

Surveys for, for instance, for unaided awareness and recall may ask a user to list the advertisements, brands, products, or services in a particular category. Responses that include a creative in the campaign (unaided awareness), or a brand, product, or service that is the target of the campaign (recall) may be considered positive consumer responses, while those that don't are considered negative consumer responses.

Once the user answers the questions on the survey, the results are sent to the collection server 140, together, for example, with the campaign project identifier, the client identifier, and the exposure frequency parameter. The collection server 140 records this information with, for instance, a time stamp of when the message was received and the IP address of the client system 110 from which the message was received. The collection server 140 aggregates this recorded information and stores this aggregated information in repository 144 as response data.

While the implementation described above initiates the survey using the beacon code that is part of the advertisement module that includes the creative shown, other implementations may initiate a survey from other advertisement modules or from the publisher or other web pages, or the surveys may be administered through other channels.

As described in more detail below, the exposure data and the response data may be used to determine one or more effectiveness metrics regarding the effectiveness of the advertising campaign at achieving the desired consumer response. For instance, this data may be used to model a control response measure (that is, a measure of the consumer response for zero exposures to an advertisement in the campaign), and the control response may be used with the data to determine an effectiveness metric.

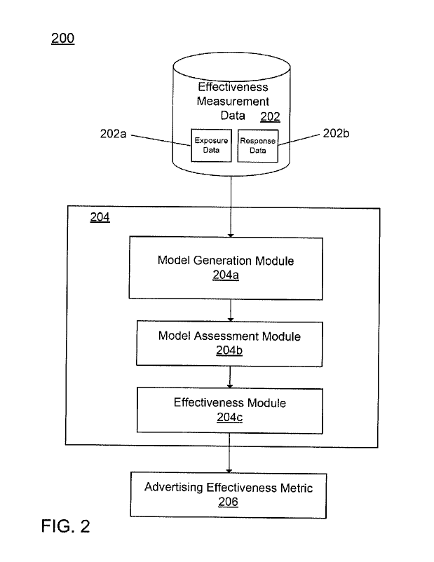

FIG. 2 illustrates an example of a system 200 in which effectiveness measurement data 202 can be used to generate an advertising effectiveness metric 206. The system 200 includes an effectiveness measurement server 204. The effectiveness measurement server 202 may be implemented using, for example, one or more processing devices capable of responding to and executing instructions in a defined manner, including, for instance, a general-purpose computer, a personal computer, a special-purpose computer, a workstation, a server, or a mobile device. The effectiveness measurement server 202 may receive instructions from, for example, a software application, a program, a piece of code, a device, a computer, a computer system, or a combination thereof, which independently or collectively direct operations. The instructions may be embodied permanently or temporarily in any type of machine, component, equipment, or other physical storage medium that is capable of being used by the effectiveness measurement server 202.

The effectiveness measurement server 202 includes one or more processing devices that execute instructions that implement a model generation module 204a, a model assessment module 204b, and an effectiveness module. The various module implemented by effectiveness measurement server 204 may perform a process, such as that shown in FIG. 4, to generate an advertising effectiveness metric 206 for one or more advertising campaigns.

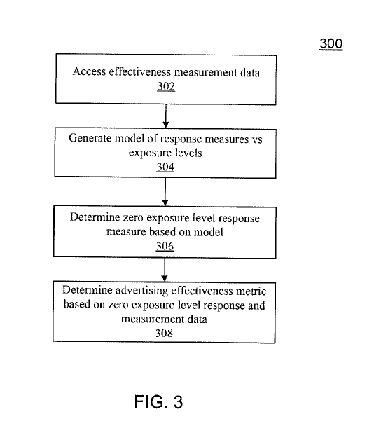

FIG. 3 is a flow chart illustrating an example of a process 300 for determining an advertising effectiveness metric for one or more advertising campaigns. The following describes process 300 as being performed by the model generation module 204a, the model assessment module 204b, and the effectiveness module 204c. However, the process 400 may be performed by other systems or system configurations.

The model generation module 204a accesses the effectiveness measurement data 202 for a group of users that have been exposed to at least one advertising creative that is part of an advertising campaign (302). The effectiveness measurement data 202 may include the exposure data 202a and the response data 202b described above with respect to FIG. 1. Thus, in one implementation, the effectiveness measurement data reflects attitudinal-based consumer responses (for example, brand favorability, intent to purchase, brand recommendation, unaided awareness, or recall).

However, in other implementations, the effectiveness measurement data may reflect behavior-based consumer responses. For example, the effectiveness data may reflect whether or not users within the group of users exposed to a creative in the campaign visited a particular website corresponding to the brand, product, or service associated with the advertising campaign. In this case, a positive consumer response may be a visit to the website. As another example, the effectiveness data may reflect whether or not the users within the group of users exposed to a creative in the campaign performed a search (for example, used a web search engine such as Google®) for the brand, product, or service associated with the advertising campaign. In this case, a positive consumer response may be the user conducting such a search. As an additional example, the effectiveness data may reflect whether or not the users within the group of users exposed to a creative in the campaign purchased a corresponding product or service, with a purchase being a positive consumer response.

Furthermore, the effectiveness measurement data 202, including the exposure data 202a and the response data 202b, may be collected in manners other than those described above with respect to FIG. 1. For example, a panel of users may have monitoring applications installed on client systems of the users, and the monitoring applications may be able to collect and report when a particular user or client system is exposed to a creative in the campaign, as well as actions taken by the users, such as visiting certain websites, searching for certain terms, or purchasing certain products from a web site. Thus, the panel may be used to obtain data regarding exposures to creatives that are part of the campaign as well as consumer responses. As another example, some of all of the data may be provided by a third party that collects such data. For instance, a third party may collect offline shopping data, which may be used to determine purchases.

In any event, the measurement data 202 reflects one or more consumer responses and one or more non-zero exposure levels. For example, the measurement data 202 may reflect, for each one of multiple non-zero exposure levels, the number of users that exhibited a positive consumer response out of the total number of the users in the group (as well as the number that exhibited a negative consumer response). Each non-zero exposure level corresponds to a non-zero amount of exposures to at least one advertising creative that is part of the advertising campaign. For instance, each level may correspond to a number of exposures to a creative in the campaign that is greater than zero. Each exposure level may encompass an individual number of exposures (e.g., 1, 2, 3) or grouped numbers of exposures (e.g., 1-5, 6-10). The following discussion describes an implementation in which each exposure level encompasses an individual number of exposures.

Based on the accessed effectiveness measurement data 202, the model generation module generates a model that relates consumer response measures to one or more exposure levels (304). For example, the consumer response measures may be the probabilities that a user exhibits a positive consumer response at a given exposure level. In this case, the generated model may relate the probabilities of a positive consumer response to the corresponding exposure levels.

In a particular example, the model may be a regression model and, specifically, a logistic regression model that determines the probability of a positive consumer response in view of a number of factors, such as the number of exposures to creatives in the campaign, age, gender, income level, and usage of the brand, product, or service. In general, a logistic regression model is based on the logistic function:

$$f ( z ) = \frac{{e}^{z}}{{e}^{z} + 1} = \frac{1}{1 + {e}^{- z}}$$

with

z=β₀+β₁x₁+β₂x₂+β₃x₃+ . . . +βₖxₖ,

where f(z) is the probability of a particular outcome (e.g., a positive consumer response), where β₀ is a constant (sometimes referred to as the “intercept”) and β₁, β₂, β₃, and so on, are called the “regression coefficients” of the factors x₁, x₂, x₃ respectively.

The values of the factors in the model may be numbers representing categories or buckets of the factors. For example, age may receive a value of 1 if the age is between 18-54 years and a 2 if the age is 55 or older; gender may receive a value of 1 if male and 2 if female; usage may receive a value of 1 if used in the past month, 2 if used over a month ago, and 3 if never used; income may receive a value of 1 if the income is less than 60K and a 2 if greater than 60K, and exposures may receive the number corresponding to the number of exposures. This is represented, for example, by the following table (Table 1):

TABLE 1

| AGE | GENDER | USAGE | Income |
|---|---|---|---|
| 1: 18-54 | 1: Male | 1: Used in the past month | 1: Less than 60K |
| 2: 55+ | 2: Female | 2: Over a month ago to | 2: More than 60K |
| | | over 12 months ago | |
| | | 3: Never | |

In other implementations, the factors may be continuous values across their ranges (for example, age could be any value between 0 and 150).

To develop the logistic model, the effectiveness data 202 may be analyzed to determine the values of the regression coefficients. For example, Markov Model Monte Carlo (MCMC) Bayesian Estimation may be applied to the measurement data to determine values of the coefficients in the logistic regression model. This data also may be analyzed to determine whether any and, if so, which factors do not affect the probabilities of a positive consumer response. The regression coefficients for those factors that do not affect the probability of a positive consumer response may be set to zero and the regression coefficients for the other factors may be set to the values determined by the MCMC Bayesian Estimation.

The following table (Table 2) illustrates an example of an output that might be produced by MCMC Bayesian Estimation performed on measurement data. The output would include the values determined for the coefficients (labeled coefficient values), the 2.50% percentile (labeled 2.50%), and the 97.50% percentile (labeled 97.50%).

The data in Table 2 demonstrates that the factors age, gender, and income level do not affect the probability of a positive consumer response. This can be noted because the value zero lies in the 95% credible interval (that is, between the values in the 2.50% column and 97.50% column) for these factors. The constant factor is the constant typically present in logistic regression models (sometimes referred to as the intercept).

TABLE 2

| | Coefficient | | |
|---|---|---|---|
| node | Values | 2.50% | 97.50% |
| Constant | 5.071 | 3.378 | 6.927 |
| Age | 0.09265 | −.4712 | 0.6564 |
| Gender | 8.21E−02 | −0.4701 | 0.6313 |
| Usage | −2.71E+00 | −3.385 | −2.108 |
| Income | −0.1674 | −0.7626 | 0.4237 |
| Exposures | 3.15E−02 | 0.001512 | 0.08354 |

The following is a table (Table 3) showing the regression coefficients based on the data shown in Table 2. As shown, the regression coefficients for age, gender, and income level are set to zero because these factors do not affect the probability of a positive consumer response.

TABLE 3

| | Constant | Age | Gender | Usage | Income | Exposures |
|---|---|---|---|---|---|---|
| Coefficient | 5.071 | 0 | 0 | −2.714 | 0 | 0.03149 |

The model assessment module 204b determines the consumer response measure (e.g., the probability of a positive consumer response) for a zero exposure level (306), while holding constant the other factors such as age, gender, income level, and usage of the brand, product, or service. The zero exposure level corresponds to zero exposures to a creative that is part of the advertising campaign and therefore may simulate a control group. The model assessment module 204b may also assess the model to obtain consumer response measures at different, non-zero exposure levels (for example, different individual numbers of exposures), while continuing to hold constant the other factors such as age, gender, income level, and usage of the brand, product, or service. For example, the other factors may be held constant at the value that is closest to the mean of the values of those factors in the measurement data 202. This further assessment may be done for a number of exposure levels that span the actual exposure levels expected to have been experienced by users during the campaign prior to determining the effectiveness metric. For instance, if the measurement data 202 is used to estimate the actual exposure levels experienced during the campaign (as described below), the further assessment may be don for a number of exposure levels that span the exposure levels expected to have been experience by the users in the group associated with the measurement data 202. Alternatively, the further assessment may be done during or before determining the effectiveness metric.

The following table (Table 4) shows an example of assessed probabilities of a positive consumer response for different exposures, using the coefficients shown in Table 3 with the logistic function. The values in the constant, age gender, usage, income, and exposures columns are the values used for the factors in the logistic function, with the regression coefficients for these factors being set to those shown in Table 3. The p column shows the probabilities of a positive consumer response, and is the result of the logistic function. As shown in the table, the exposures are varied (and include a zero-exposure value), while the other factors are kept constant. The lifts column show the percent change in the probability of a positive consumer response for the given number of exposures shown in the row relative to the probability of a positive consumer response for zero exposures. While only 30 exposures are shown, additional exposure levels may be assessed.

TABLE 4

| Con- | | | | In- | Expo- | | |
|---|---|---|---|---|---|---|---|
| stant | Age | Gender | Usage | come | sures | p | Lifts |
| 1 | 1 | 1 | 3 | 1 | 0 | 0.04431945 | |
| 1 | 1 | 1 | 3 | 1 | 1 | 0.04567252 | 2.96% |
| 1 | 1 | 1 | 3 | 1 | 2 | 0.04706487 | 5.83% |
| 1 | 1 | 1 | 3 | 1 | 3 | 0.0484975 | 8.61% |
| 1 | 1 | 1 | 3 | 1 | 4 | 0.04997146 | 11.31% |
| 1 | 1 | 1 | 3 | 1 | 5 | 0.05148779 | 13.92% |
| 1 | 1 | 1 | 3 | 1 | 6 | 0.05304756 | 16.45% |
| 1 | 1 | 1 | 3 | 1 | 7 | 0.05465186 | 18.91% |
| 1 | 1 | 1 | 3 | 1 | 8 | 0.05630179 | 21.28% |
| 1 | 1 | 1 | 3 | 1 | 9 | 0.05799848 | 23.59% |
| 1 | 1 | 1 | 3 | 1 | 10 | 0.05974307 | 25.82% |
| 1 | 1 | 1 | 3 | 1 | 11 | 0.0615367 | 27.98% |
| 1 | 1 | 1 | 3 | 1 | 12 | 0.06338055 | 30.07% |
| 1 | 1 | 1 | 3 | 1 | 13 | 0.06527581 | 32.10% |
| 1 | 1 | 1 | 3 | 1 | 14 | 0.06722367 | 34.07% |
| 1 | 1 | 1 | 3 | 1 | 15 | 0.06922535 | 35.98% |
| 1 | 1 | 1 | 3 | 1 | 16 | 0.07128209 | 37.83% |
| 1 | 1 | 1 | 3 | 1 | 17 | 0.07339511 | 39.62% |
| 1 | 1 | 1 | 3 | 1 | 18 | 0.07556567 | 41.35% |
| 1 | 1 | 1 | 3 | 1 | 19 | 0.07779503 | 43.03% |
| 1 | 1 | 1 | 3 | 1 | 20 | 0.08008446 | 44.66% |
| 1 | 1 | 1 | 3 | 1 | 21 | 0.08243525 | 46.24% |
| 1 | 1 | 1 | 3 | 1 | 22 | 0.08484868 | 47.77% |
| 1 | 1 | 1 | 3 | 1 | 23 | 0.08732604 | 49.25% |
| 1 | 1 | 1 | 3 | 1 | 24 | 0.08986863 | 50.68% |
| 1 | 1 | 1 | 3 | 1 | 25 | 0.09247775 | 52.08% |
| 1 | 1 | 1 | 3 | 1 | 26 | 0.0951547 | 53.42% |
| 1 | 1 | 1 | 3 | 1 | 27 | 0.09790078 | 54.73% |
| 1 | 1 | 1 | 3 | 1 | 28 | 0.10071729 | 56.00% |
| 1 | 1 | 1 | 3 | 1 | 29 | 0.10360552 | 57.22% |
| 1 | 1 | 1 | 3 | 1 | 30 | 0.10656676 | 58.41% |

While the foregoing describes an example in which the factors other than the exposures are held constant at one set of values, other implementations may determine the consumer response measures-per-exposure level for different sets of values for the other factors, determine the percent changes, determine the weighted average of the percent changes across the different sets (weight by proportion of the users that match the set of values for the other factors), and then set those weighted averages of the percent changes equal to the “lifts” for a given exposure level.

For example, the probabilities and percent change (lifts) may be calculated as shown in Table 4 for a first set of values of age=1, gender=1, usage=3, and income=1. Then the probabilities and corresponding lifts may be calculated for a different, second set of values for the factors, such as age=2 (assuming age affects the probabilities), gender=1, usage=3, and income=1. The lifts for the first set may be weighted by the proportion or percentage of users in the group that match age=1, gender=1, usage=3, and income=1 and the lifts for the second set may be weighted by the proportion or percentage of users in the group that match age=2, gender=1, usage=3, and income=1. These weighted lifts can be summed to obtain weighted average lifts for the exposure levels across the two sets. This can be performed across all combinations of factor values to determine weighted average lifts per exposure level across all sets of factor values. These weighted average lifts may then be used rather than lifts determine based on only a single set of factor values when determining the advertising effectiveness metric using, for example, the procedure described below.

The effectiveness module 204c determines an advertising effectiveness metric 206 for the campaign based on the consumer response measure for the zero exposure level and the accessed measurement data (308). For example, the metric may be a weighted average change of the consumer response measures (e.g., probabilities of a positive consumer response), relative to the consumer response measure at the zero exposure level (determined based on the model), for the exposure levels contained in an estimate of the exposure levels specifically experienced by users during the campaign. A number of different techniques may be used to estimate the exposure distribution for the campaign (that is, the exposure levels specifically experienced by users during the campaign). For instance, the measurement data 202c may be used to estimate the exposure distribution by using the data to determine the exposure levels specifically experience by users in the group associated with the measurement data 202.

As an example, determining the weighted average change may entail assessing the model to determine the consumer response measures (e.g., probability of a positive consumer response) for the particular exposure levels experienced by the users in the group associated with the measurement data 202. As described above, the model assessment module 204b may perform this assessment prior to the effectiveness module 204c determining the effectiveness metric, or while the effectiveness module 204c is determining the effectiveness metric (for example, in response to a request from the effectiveness module 204c for this information). The effectiveness module 204c may then determine the change of the consumer response measure at each of the particular exposure levels experience by the group relative to the consumer response measure at the zero exposure level. The change at each level may be determined as a percentage of the consumer response measure at that level.

The effectiveness module 204c may determine, for each exposure level actually experience by the group, the percentage of the users in the group at the exposure level. The effectiveness module 204c then may determine the effectiveness metric 206 as the sum of the percentage of the users at each exposure level multiplied by the change (e.g., percent change) at each exposure level.

The following table (Table 5) shows an example of determining a weighted average of the change for the advertising effectiveness metric. The exposures column includes the number of exposures to a creative in the campaign (and the numbers included are for the actual exposure levels experienced by the group), the percentage column includes the percentage of users in the group that received the number of exposures in the exposure column, and the lift column includes the percentage change of the consumer response measure (e.g., probability of a positive consumer response) at the number of exposures in the exposure column relative to the consumer response for zero exposures. The “average lift” is the sum of the lift values weighted by the corresponding percentage values and corresponds to the advertising effectiveness metric, for one implementation.

| Exposures | Percentage | Lift |
|---|---|---|
| 1 | 16.6 | 2.96% |
| 2 | 53.9 | 5.83% |
| 3 | 7.5 | 8.61% |
| 4 | 5.4 | 11.31% |
| 5 | 2 | 13.92% |
| 6 | 2.4 | 16.45% |
| 7 | 2 | 18.91% |
| 8 | 0.7 | 21.28% |
| 9 | 1 | 23.59% |
| 10 | 1.7 | 25.82% |
| 11 | 0.7 | 27.98% |
| 12 | 0.7 | 30.07% |
| 13 | 0.3 | 32.10% |
| 14 | 0.3 | 34.07% |
| 16 | 0.7 | 37.83% |
| 17 | 0.7 | 39.62% |
| 18 | 0.3 | 41.35% |
| 20 | 0.7 | 44.66% |
| 22 | 0.3 | 47.77% |
| 25 | 0.3 | 52.08% |
| 30 | 0.3 | 58.41% |
| 35 | 0.3 | 63.82% |
| 36 | 0.3 | 64.81% |
| 50 | 0.3 | 75.77% |
| 57 | 0.3 | 79.69% |
| 58 | 0.3 | 80.75% |
| | AVERAGE LIFT | 9.92% |

While the above describes determining the advertising effectiveness metric using the exposure distribution for the campaign estimated based on the users in the group associated with the measurement data, other implementations may use estimates of the exposure distribution derived in other ways, as previously noted. For example, a panel of users may have monitoring applications installed on client systems of the users, and the monitoring applications may be able to collect and report when a particular user or client system is exposed to a creative in the campaign. This information may be used to estimate the exposure levels actually experienced during the campaign, and the percentage of users (or client systems) in the panel at each of those exposure levels may be used as the weighting factor (rather than the percentage of users in the group associated with the measurement data 202c). Thus, in some implementations, the measurement data 202c may be used to determine the model, which is used to determine the response measure at the zero exposure frequency and the change in response measures at the appropriate exposure levels, as described above, while other data is used to estimate the exposure distribution during the campaign and determine the appropriate weighting factors at each of the exposure levels in the estimated exposure distribution.

Furthermore, rather than a weighted average of the changes, other implementations may determine the advertising effectiveness based on the change between the zero-exposure response measure and the response measure for the average number of exposures experienced during the campaign (which may be estimated based on the measurement data or other data, as similarly described above with respect to the exposure distribution). For example, the average number of exposures may be estimated by determining the average number of exposures experience by the group of users associated with the measurement data (potentially adjusted to take into account the number of users that would have been included in the zero-exposure group if a control group was maintained). For example, if an analysis of the accessed measurement data (or other data) indicates that the average number of exposures was 4, then the advertising effectiveness metric may be set to 11.31% (as shown in Table 5).

The techniques can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

A number of implementations of the techniques have been described. Nevertheless, it will be understood that various modifications may be made. For example, useful results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. An system comprising:
one or more processing devices;
one or more storage devices storing instructions that, when executed by the one or more processing devices, causes the one or more processing devices to:
access measurement data associated with a group of users that have been exposed to at least one advertising creative that is part of an advertising campaign, the measurement data reflecting one or more consumer responses and one or more non-zero exposure levels, wherein the non-zero exposure levels correspond to non-zero amounts of exposures to at least one advertising creative that is part of the advertising campaign;
generate a model that relates consumer response measures to one or more exposure levels based on the accessed measurement data;
determine, based on the generated model, a consumer response measure for a zero exposure level, wherein the zero exposure level corresponds to a zero amount of exposures to at least one advertising creative that is part of the advertising campaign; and
determine an advertising effectiveness metric based on the consumer response measure for the zero exposure level and the accessed measurement data.

2. The system of claim 1 wherein each of the one or more non-zero exposure levels corresponds to an individual, non-zero number of exposures.

3. The system of claim 1 wherein, to generate the model, the instructions include instructions that, when executed by the one or more processing devices, causes the one or more processing devices to generate, based one the accessed measurement data, a model that relates consumer response measures to exposure levels while holding other factors constant.

4. The system of claim 3 wherein the other factors include age, gender, income level, or usage.

5. The system of claim 1 wherein the consumer response measures are probabilities of a positive consumer response.

6. The system of claim 1 wherein, to determine the advertising effectiveness metric, the instructions include instructions that, when executed by the one or more processing devices, causes the one or more processing devices to:
determine an estimate of the exposure distribution for the advertising campaign, the exposure distribution including one or more non-zero exposure levels experienced during the campaign;
determine, based on the model, consumer response measures for the non-zero exposure levels in the estimate of the exposure distribution;
determine changes of the determined consumer response measures for the non-zero exposure levels in the estimate of the exposure distribution relative to the consumer response measure for the zero exposure level; and
determine an advertising effectiveness metric based on the changes.

7. The system of claim 6 wherein, to determine the estimate, the instructions include instructions that, when executed by the one or more processing devices, causes the one or more processing devices to determine the non-zero exposure levels reflected by the measurement data.

8. The system of claim 7 wherein, to determine an advertising effectiveness metric based on the changes, the instructions include instructions that, when executed by the one or more processing devices, causes the one or more processing devices to:
determine a proportion of the users in the group at each non-zero exposure level reflected by the measurement data;
weight the changes by the corresponding proportions; and
sum the weighted changes.

9. The system of claim 8 wherein the changes are percent changes and the proportions are the percentages of users in the group at each non-zero exposure level.

10. The system of claim 9 wherein, to determine the estimate, the instructions include instructions that, when executed by the one or more processing devices, causes the one or more processing devices to determine one or more non-zero exposure levels experienced by users of a panel.

11. The system of claim 10 wherein, to determine an advertising effectiveness metric based on the changes, the instructions include instructions that, when executed by the one or more processing devices, causes the one or more processing devices to:
determine a proportion of the users in the panel at each non-zero exposure level experienced by the users of the panel;
weight the changes by the corresponding proportions; and
sum the weight changes

12. The system of claim 1 wherein, to determine the advertising effectiveness metric, the instructions include instructions that, when executed by the one or more processing devices, causes the one or more processing devices to:
determine a non-zero exposure level that corresponds to an average number of exposures for the group;
determine a consumer response measure for the non-zero exposure level that corresponds to an average number of exposures for the group; and
determine a change of the consumer response measure for the non-zero exposure level that corresponds to an average number of exposures for the group relative to the consumer response measure for the zero exposure level.

13. The system of claim 12 wherein the change is a percent change.

14. The system of claim 1 wherein the advertising effectiveness measure indicates an effectiveness with respect to one or more attitudinal or behavioral responses.

15. The system of claim 14 wherein the attitudinal responses include one or more of brand favorability, intent to purchase, brand recommendation, unaided awareness, or recall

16. The system of claim 14 wherein the behavioral responses include one or more of website visitation, brand, product, or service searching, or purchase of a product or service.

17. An method comprising:
accessing measurement data associated with a group of users that have been exposed to at least one advertising creative that is part of an advertising campaign, the measurement data reflecting one or more consumer responses and one or more non-zero exposure levels, wherein the non-zero exposure levels correspond to non-zero amounts of exposures to at least one advertising creative that is part of the advertising campaign;
generating a model that relates consumer response measures to one or more exposure levels based on the accessed measurement data;
determining, based on the generated model, a consumer response measure for a zero exposure level, wherein the zero exposure level corresponds to a zero amount of exposures to at least one advertising creative that is part of the advertising campaign; and
determining an advertising effectiveness metric based on the consumer response measure for the zero exposure level and the accessed measurement data.

18. The method of claim 17 wherein determining includes:
determining an estimate of the exposure distribution for the advertising campaign, the exposure distribution including one or more non-zero exposure levels experienced during the campaign;
determining, based on the model, consumer response measures for the non-zero exposure levels in the estimate of the exposure distribution;
determining changes of the determined consumer response measures for the non-zero exposure levels in the estimate of the exposure distribution relative to the consumer response measure for the zero exposure level; and
determining an advertising effectiveness metric based on the changes.

19. The method of claim 18 wherein determining the estimate comprises determining the non-zero exposure levels reflected by the measurement data.

20. The method of claim 19 wherein determining an advertising effectiveness metric based on the changes comprises:
determining a proportion of the users in the group at each non-zero exposure level reflected by the measurement data;
weighting the changes by the corresponding proportions; and
summing the weighted changes.

21. The method of claim 17 wherein determining the advertising effectiveness metric includes:
determining a non-zero exposure level that corresponds to an average number of exposures for the group;
determining a consumer response measure for the non-zero exposure level that corresponds to an average number of exposures for the group; and
determining a change of the consumer response measure for the non-zero exposure level that corresponds to an average number of exposures for the group relative to the consumer response measure for the zero exposure level.

22. A system comprising:
one or more processing devices;
one or more storage devices storing instructions that, when executed by the one or more processing devices, causes the one or more processing devices to:
access measurement data associated with a group of users that have been exposed to at least one advertising creative that is part of an advertising campaign, the measurement data reflecting, for each one of multiple non-zero exposure levels, an amount of the users from the group corresponding to a positive consumer response, wherein each non-zero exposure level corresponds to a non-zero amount of exposures to at least one advertising creative that is part of the advertising campaign;
generate a model that relates probabilities of a positive consumer response to exposure levels based on the accessed measurement data;
determine, based on the generated model, a probability of a positive consumer response for a zero exposure level, wherein the zero exposure level corresponds to a zero amount of exposures to at least one advertising creative that is part of the advertising campaign; and
determine an advertising effectiveness metric based on the probability of a positive consumer response for the zero exposure level and the accessed measurement data.

23. A method comprising:
accessing measurement data associated with a group of users that have been exposed to at least one advertising creative that is part of an advertising campaign, the measurement data reflecting, for each one of multiple non-zero exposure levels, an amount of the users from the group corresponding to a positive consumer response, wherein each non-zero exposure level corresponds to a non-zero amount of exposures to at least one advertising creative that is part of the advertising campaign;
generating a model that relates probabilities of a positive consumer response to exposure levels based on the accessed measurement data;
determining, based on the generated model, a probability of a positive consumer response for a zero exposure level, wherein the zero exposure level corresponds to a zero amount of exposures to at least one advertising creative that is part of the advertising campaign; and
determining an advertising effectiveness metric based on the probability of a positive consumer response for the zero exposure level and the accessed measurement data.
